(19) United States
(12) Patent Application Publication
(10) Pub. No.: US 2013/0088740 A1
(43) Pub. Date: Apr. 11, 2013

(54) IMAGE FORMING SYSTEM AND IMAGE FORMING METHOD

(71) Applicant: Michiaki NISHIMURA, Osaka (JP)

(72) Inventor: Michiaki NISHIMURA, Osaka (JP)

(73) Assignee: SHARP KABUSHIKI KAISHA, Osaka (JP)

(21) Appl. No.: 13/611,430

(22) Filed: Sep. 12, 2012

(30) Foreign Application Priority Data
Oct. 11, 2011 (JP) 2011-223830

(51) Int. Cl. G06F 3/12

(52) U.S. Cl. 358/1.14

(57) ABSTRACT

When a nongenuine product is used as a replacement part of an image forming apparatus, addition of specific image information to recording paper is prohibited, thereby preventing leakage of an important document. The image forming apparatus includes an image forming portion for forming an image, and a nongenuine product judging portion for judging whether or not a toner cartridge as a replacement part of the image forming portion is a nongenuine product. A printer driver of an information processing apparatus prohibits, when the toner cartridge of the image forming portion is judged as a nongenuine product, addition to recording paper a watermark, copy prohibition information or trace information that is purposely added as the specific image information on a print condition input screen with recognition of an important document by a user.

### CROSS-NOTING PARAGRAPH

This non-provisional application claims priority under 35 U.S.C. §119(a) on Patent Application No. 2011-223830 filed in JAPAN on Oct. 11, 2011, the entire contents of which are hereby incorporated herein by reference.

### FIELD OF THE INVENTION

The present invention relates to an image forming system and an image forming method, and more particularly to an image forming system and an image forming method for restricting a particular image forming function in a case where a replacement part is a nongenuine product.

### BACKGROUND OF THE INVENTION

For replacement parts of a photoreceptor drum, a transfer belt, a toner cartridge and the like which are used for an image forming apparatus such as a multi-functional peripheral, a distributor of a device provides genuine supplies for assuring print quality, while a third party other than the distributor has been increasingly selling supplies as interchangeable parts. The interchangeable parts are inexpensively supplied, whose print quality is however not assured at all, and a seller of the interchangeable parts has not been responsible for maintenance of equipment under the circumstances. Further, since such a multi-functional peripheral is not designed to support even nongenuine supplies, in the case of using a nongenuine product, blur, fog and the like of printing are notably caused under environmental conditions such as high temperature, high humidity, low temperature, low humidity and the like, posing a problem of reduction in print quality.

Whereas, for example, Japanese Laid-Open Patent Publication No. 2010-266588 describes an image forming apparatus identifiable whether or not a replacement part is a genuine product. In such an image forming apparatus, manufacturer name information of a toner is read from a memory tag incorporated in a toner cartridge to compare the read company name information to company name information stored in advance, and determination is made, in the case of match, that a mounted toner cartridge is a genuine product to display the company name information on a display portion, followed by execution of image density correction operation. On the other hand, determination is made, in the case of mismatch, that the mounted toner cartridge is a nongenuine product not to display the company name information on the display portion, as well as displaying that the image density correction operation is not executed.

Additionally, Japanese Laid-Open Patent Publication No. 2009-300694 describes an image forming apparatus capable of selecting a first mode assuming use of genuine consumables and a second mode permitting use of nongenuine consumables. Such an image forming apparatus is comprised of consumable judgment means for judging whether a mounted consumable is genuine or nongenuine, and print job receiving means for receiving a print instruction, in which, when the first mode is selected, in a case where a consumable to be used in order to reproduce a color instructed for printing in the print job receiving means includes a consumable judged as nongenuine by the consumable judgment means, the consumable judged as nongenuine is not used, and only the consumable judged as genuine is used to form an image.

Since an administrator generally performs replacement and replenishment for the above-described supplies, a general user performs printing believing that favorable printing is performed under the circumstances. In such a case, when an important document such as a confidential document is printed, as specific image information concerning security, additional information indicating importance of a printed material with a watermark, copy prohibition information for prohibiting copy of a printed material with a known art such as a background pattern, or trace information for embedding information indicating a printer of a printed material, a user and the like to trace a source of the printed material are purposely added to the printed material in some cases. However, in the case of using the above-described supplies provided by a third party whose print quality is not assured, unsuccessful printing of these watermark, copy prohibition information or trace information may arise.

Specifically, a watermark is provided for combining watermark characters of a document to be printed for performing printing, in which the watermark character becomes light with a nongenuine supply so that the watermark is not embossed in copying, while the watermark becomes too dark so that the printed document becomes impossible to be read, in some cases. Further, the copy prohibition information and the trace information are printed by combining a special symbol or background pattern, or the like with the document to be printed, and such information is printed on recording paper as hidden information in gray, yellow or the like so as to be difficult to be recognized by user's eyes.

In this manner, printing of the background pattern, the watermark or the like is background printing for indicating importance of a printed material without deteriorating inherent visibility of a document, and thus realized by fine dot printing with a less number of dots per unit area compared to a major document to be printed, or the like. Thus, in the case of using a nongenuine product, there is a possibility that it is impossible to obtain a desired printing result because a size of a toner particle thereof is not appropriate, or the like, which results in no use as a printed material. Additionally, such hidden information is not readable so that copy of a printed material becomes available, and the trace information is not readable so that it is impossible to maintain security desired by a user, which poses a problem.

With techniques described in the above-described Japanese Laid-Open Patent Publication No. 2010-266588 and Japanese Laid-Open Patent Publication No. 2009-300694, it is impossible to perform favorable printing in the case of detecting that a toner cartridge is a nongenuine product, thus prohibiting image density correction, or performing printing only with a genuine product without using a nongenuine product in a case where high image quality is required, however, the above-described problems have been never considered. Further, in a case where a nongenuine product is used, there is also a method of prohibiting all printing operation, however, a uniform ban results in significantly impaired user's convenience.

### SUMMARY OF THE INVENTION

An object of the present invention is to provide an image forming system and an image forming method capable of prohibiting addition of specific image information to recording paper in the case of detecting use of a nongenuine product other than a genuine product supplied by a manufacturer of an image forming apparatus inside thereof, thereby informing a general user of a problem for security in the case of creating an important document, so that it is possible to prevent leakage of a confidential matter.

An object of the present invention is to provide an image forming system in which an information processing apparatus to which a printer driver is installed and an image forming apparatus that is controlled by the printer driver are connected to each other via a network, wherein the image forming apparatus is provided with an image forming portion for forming an image; a nongenuine product judging portion for judging whether or not a replacement part of the image forming portion is a nongenuine product; and a communication portion for sending a judgment result by the nongenuine product judging portion to the information processing apparatus, wherein the printer driver of the information processing apparatus prohibits, when the judgment result from the image forming apparatus is a nongenuine product, addition of specific image information to recording paper among image forming conditions capable of being input from a print condition input screen of the printer driver.

Another object of the present invention is to provide the image forming system, wherein the specific image information is any of a watermark, copy prohibition information or printed material trace information.

Another object of the present invention is to provide the image forming system, wherein the printer driver of the information processing apparatus hides, when the judgment result from the image forming apparatus is a nongenuine product, a setting item concerning addition of the specific image information to recording paper on the print condition input screen.

Another object of the present invention is to provide the image forming system, wherein the printer driver of the information processing apparatus displays in gray-out, when the judgment result from the image forming apparatus is a nongenuine product, a setting item concerning addition of the specific image information to recording paper on the print condition input screen.

Another object of the present invention is to provide the image forming system, wherein the nongenuine product judging portion judges, in the case of being incapable of obtaining predetermined information from a replacement part of the image forming portion, that the replacement part is a nongenuine part.

Another object of the present invention is to provide an image forming method in an image forming system in which an information processing apparatus to which a printer driver is installed and an image forming apparatus that is controlled by the printer driver are connected to each other via a network, wherein the image forming apparatus includes an image forming portion for forming an image; a nongenuine product judging step for judging whether or not a replacement part of the image forming portion is a nongenuine product; and a communicating step for sending a judgment result in the nongenuine product judging step to the information processing apparatus, wherein the printer driver of the information processing apparatus includes an input restricting step of prohibiting, when the judgment result from the image forming apparatus is a nongenuine product, addition of specific image information to recording paper among image forming conditions capable of being input from a print condition input screen of the printer driver.

### BRIEF DESCRIPTION OF THE DRAWINGS

FIG. 1 is a diagram showing an embodiment in which an image forming apparatus in an image forming system according to the present invention is configured as a multi-functional peripheral;

FIG. 2 is a block diagram showing an exemplary main configuration of the image forming apparatus and an information processing apparatus in the image forming system according to the present invention;

FIG. 3 is a diagram showing an example of a toner cartridge as a replacement part;

FIG. 4 is a flow diagram explaining an example of operation of the image forming apparatus in the image forming system of the present invention;

FIG. 5 is a flow diagram explaining an example of operation of the information processing apparatus in the image forming system of the present invention;

FIG. 6 is a diagram showing an example of a print condition input screen with a printer driver in the case of using a genuine product;

FIG. 7 is a diagram showing an example of a print condition input screen with the printer driver in the case of using a nongenuine product; and

FIG. 8 is a diagram showing another example of a print condition input screen with the printer driver in the case of using a nongenuine product.

### PREFERRED EMBODIMENTS OF THE INVENTION

Hereinafter, description will be given for preferred embodiments of an image forming system and an image forming method of the present invention with reference to drawings.

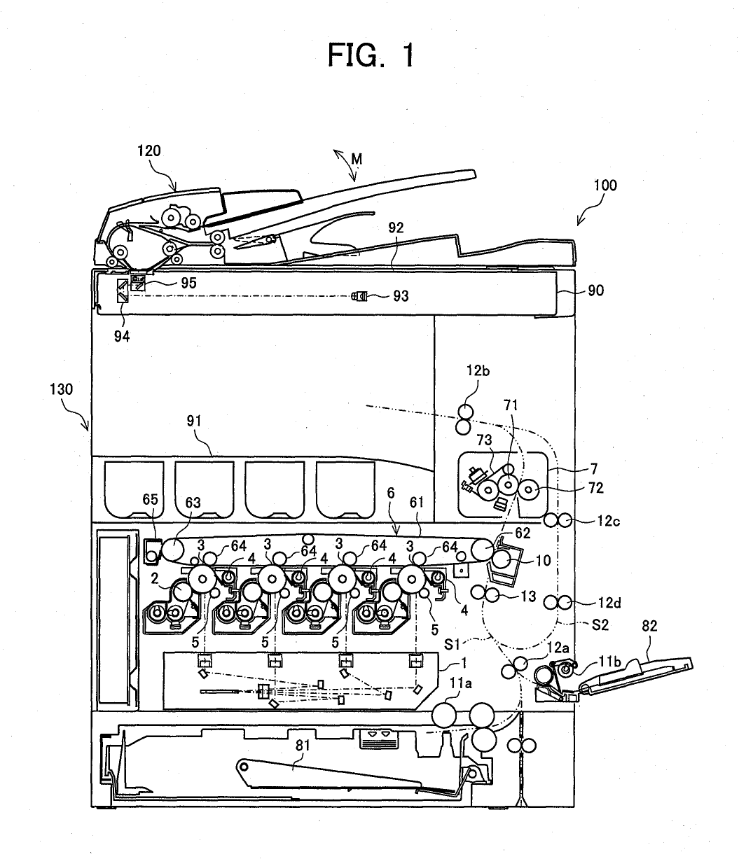

FIG. 1 is a diagram showing an embodiment in which an image forming apparatus according to the present invention is configured as a multi-functional peripheral, showing an example of the image forming apparatus configured as a multi-functional peripheral provided with a scanner function.

An image forming apparatus 100 is to form as an image on recording paper image data which is transmitted from the outside, or read by a scanner (image reading means), and comprised of an apparatus body 130 and an automatic document processing device 120.

The apparatus body 130 includes an exposure unit 1, developing equipment 2, a photoreceptor drum 3, a cleaner unit 4, a charger 5, an intermediate transfer belt unit 6, a fixing unit 7, a paper feeding cassette 81, a paper discharge tray 91 and the like.

In an upper part of the apparatus body 130, a document platen 92 made of transparent glass is provided, and on an upper side thereof, the automatic document processing device 120 is installed for automatically feeding a document onto the document platen 92. The automatic document processing device 120 is configured so as to rotate freely in an arrow M direction, and the top of the document platen 92 is opened so that it is possible to place a document by hand.

The apparatus body 130 includes image reading means 90 that is contained in a housing. The image reading means 90 is reduced optical system image reading means which is comprised of a light source unit 93 holding a light source and a first mirror, a mirror unit 94 holding a second mirror and a third mirror, a lens and a CCD 95. Further, the apparatus body 130 is provided with a not-shown operation panel so as to enable operation input by a user. Moreover, the apparatus body 130 is provided with means for inputting image data from a device connected to the outside, or means for reading image data from a transportable recording medium (both of them are not illustrated).

Image data which is processed in the image forming apparatus 100 corresponds to a color image in four colors of black (K), cyan (C), magenta (M) and yellow (Y), for example. Accordingly, four pieces for each of the developing equipment 2, the photoreceptor drum (image carrier) 3, the charger 5 and the cleaner unit 4 are provided so as to form four types of latent images corresponding to each of the colors, whereby four image stations are constituted.

The charger 5 is charging means for uniformly charging the surface of the photoreceptor drum 3 to predetermined potential, and for which, a contact-type roller type or brush type of a charger is used in addition to a charger type thereof as shown in FIG. 1 in some cases.

The exposure unit 1 is configured as a laser scanning unit (LSU) provided with a laser emission portion, a reflective mirror and the like. In the exposure unit 1, a polygon mirror that scans by a laser beam, and optical elements such as a lens and a mirror for guiding a laser beam that is reflected by the polygon mirror to the photoreceptor drum 3 are arranged. In addition, for the exposure unit 1, it is also possible to employ a method of using, for example, EL and LED writing heads in which light-emitting devices are disposed in an array.

The exposure unit 1 includes a function for exposing the charged photoreceptor drum 3 according to input image data, thereby, on which surface, forming an electrostatic latent image according to the image data. The developing equipment 2 visualizes the electrostatic latent image that is formed on each of the photoreceptor drums 3 with toners in four colors (Y, M, C and K). Further, the cleaner unit 4 removes/collects a toner which remains on the surface of the photoreceptor drum 3 after development and image transfer.

The intermediate transfer belt unit 6 that is arranged on an upper side of the photoreceptor drum 3 is provided with an intermediate transfer belt 61, an intermediate transfer belt driving roller 62, an intermediate transfer belt driven roller 63, an intermediate transfer roller 64 and an intermediate transfer belt cleaning unit 65. Four intermediate transfer rollers 64 are provided corresponding to each color of Y, M, C and K.

The intermediate transfer belt 61. is stretched out among and rotationally driven by the intermediate transfer belt driving roller 62, the intermediate transfer belt driven roller 63 and the intermediate transfer roller 64. Further, each intermediate transfer roller 64 imparts transfer bias for transferring a toner image of the photoreceptor drum 3 onto the intermediate transfer belt 61.

The intermediate transfer belt 61 is provided in contact with each photoreceptor drum 3. Then, toner images in respective colors that are formed on the photoreceptor drum 3 are sequentially superimposed on and transferred onto the intermediate transfer belt 61, thereby forming a color toner image (multicolor toner image) on the intermediate transfer belt 61. The intermediate transfer belt 61 is formed in an endless shape with use of, for example, a film with thickness of about 100 μm to 150 μm.

The toner image is transferred from the photoreceptor drum 3 to the intermediate transfer belt 61 by the intermediate transfer roller 64 in contact with a back side of the intermediate transfer belt 61. To the intermediate transfer roller 64, high-voltage transfer bias (high voltage with polarity (+) opposite to charging polarity (−) of a toner) is applied in order to transfer the toner image. The intermediate transfer roller 64 is a roller using a metal (for example, stainless-steel) axis with a diameter of 8 to 10 mm, whose surface is covered by a conductive elastic material (for example, EPDM, urethane form or the like). Such a conductive elastic material allows high voltage to be uniformly applied to the intermediate transfer belt 61. In this structural example, a roller shape is used as transfer electrode, however, a brush type or the like is also usable otherwise.

An electrostatic image which is visualized on each photoreceptor drum 3 corresponding to each color phase as described above is layered on the intermediate transfer belt 61. The electrostatic image layered in this manner is transferred onto recording paper by the transfer roller 10 as a secondary transfer mechanical portion described below that is arranged in a contact position of a sheet and the intermediate transfer belt 61 by rotation of the intermediate transfer belt 61. As the secondary transfer mechanical portion, not only a transfer roller but also a corona charger as well as a transfer belt are also usable.

At the time, the intermediate transfer belt 61 is brought into pressure-contact with the transfer roller 10 by a predetermined nip, while voltage is applied to the transfer roller 10 in order to transfer a toner to a sheet (high voltage of polarity (+) opposite to charging polarity (−) of a toner). Further, for the purpose of steadily obtaining the above-described nip by the transfer roller 10, either one of the transfer roller 10 or the intermediate transfer belt driving roller 62 is made of a hard material (metal or the like), and the other is made of a soft material such as an elastic roller (an elastic rubber roller, a formable resin roller or the like).

Moreover, as described above, a toner which is attached to the intermediate transfer belt 61 by contact with the photoreceptor drum 3 or a toner which remains on the intermediate transfer belt 61 without being transferred onto recording paper by the transfer roller 10 is, because of causing generation of a mixed color of toners at next step, set to be removed/collected by the intermediate transfer belt cleaning unit 65. The intermediate transfer belt cleaning unit 65 is provided with, for example, a cleaning blade as a cleaning member in contact with the intermediate transfer belt 61, and the intermediate transfer belt 61 in contact with the cleaning blade is supported by the intermediate transfer belt driven roller 63 on the back side thereof.

The paper feeding cassette 81 is a tray for accumulating recording paper (sheets) to be used for image formation, and provided on a lower side of the exposure unit 1 of the apparatus body 130. Additionally, the recording paper to be used for image formation is able to be placed also in a manual paper feeding cassette 82. Further, the paper discharge tray 91 provided above the apparatus body 130 is a tray for piling up the printed recording paper facedown.

Further, the apparatus body 130 is provided with a paper conveyance path S1 in an approximately vertical shape for feeding recording paper in the paper feeding cassette 81 and the manual paper feeding cassette 82 to the paper discharge tray 91 through the transfer roller 10 and the fixing unit 7. Near the paper conveyance path S1 from the paper feeding cassette 81 or the manual paper feeding cassette 82 to the paper discharge tray 91, pick-up rollers 11a and 11b, a plurality of conveying rollers 12a to 12d, a registration roller 13, the transfer roller 10, the fixing unit 7 and the like are arranged.

The conveying rollers 12a to 12d are small-size rollers for promoting and assisting conveyance of recording paper, a plurality of which are arranged along the paper conveyance path S1. Further, the pick-up roller 11a is provided near the end of the paper feeding cassette 81, and picks recording paper up from the paper feeding cassette 81 sheet by sheet for supplying to the paper conveyance path S1. Similarly, the pick-up roller 11b is provided near the end of the manual paper feeding cassette 82, and picks recording paper up from the manual paper feeding cassette 82 sheet by sheet for supplying to the paper conveyance path S1.

Furthermore, the registration roller 13 keeps once the recording paper conveyed through the paper conveyance path S1. Additionally, provided is a function for conveying recording paper to the transfer roller 10 at the time of lining up a leading end of a toner image on the photoreceptor drum 3 to a leading end of the recording paper.

The fixing unit 7 is provided with a heat roller 71 and a pressurizing roller 72. The heat roller 71 and the pressurizing roller 72 rotate by holding recording paper therebetween. Additionally, the heat roller 71 is set so as to be at predetermined fixing temperature by control means based on a signal from a not-shown temperature detector, and has a function for bringing a toner together with the pressurizing roller 72 into thermocompression bonding to recording paper, thereby applying fusing, mixing and pressure-contact to a multicolor toner image that is transferred to the recording paper for allowing the recording paper to be subjected to heat fixing. Further, an outer heating belt 73 is provided for heating the heat roller 71 from outside.

Next, description will be given more specifically for a conveyance path of recording paper. As described above, the image forming apparatus 100 is provided with the paper feeding cassette 81 and the manual paper feeding cassette 82 for containing recording paper in advance. In order to feed recording paper from these paper feeding cassettes 81 and 82, for which, the pick-up rollers 11a and 11b are respectively arranged to guide the recording paper to the paper conveyance path S1 sheet by sheet.

The recording paper that is conveyed from each of the paper feeding cassettes 81 and 82 is conveyed to the registration roller 13 by the conveying roller 12a of the paper conveyance path S1, then conveyed to the transfer roller 10 at the time of lining up a leading end of the recording paper to a leading end of image information on the intermediate transfer belt 61, in which the image information is written onto the recording paper. Thereafter, the recording paper passes through the fixing unit 7, whereby an unfixed toner on the recording paper is fused and fixed by heat, then discharged onto the paper discharge tray 91 through the arranged conveying roller 12b.

The above-described conveyance path is provided in the case of a request for single-sided printing for recording paper, and on the other hand, in the case of a request for double-sided printing, when a rear end of the recording paper which passes through the fixing unit 7 after finishing the single-sided printing as described above is held by the last conveying roller 12b, the recording paper is guided to a conveyance path S2 in which the conveying rollers 12c and 12d are arranged by a reverse rotation of the conveying roller 12b. Then, the conveyance path S2 joins the conveyance path S1, and the recording paper is conveyed from the registration roller 13 to the transfer roller 10. At the time, the recording paper is reversed at a stage of joining from the conveyance path S2 to the conveyance path S1, and printing is thus performed on the back side of the recording paper at the transfer roller 10. Then, the recording paper whose back side is printed is fixed by the fixing unit 7 to be discharged to the paper discharge tray 91.

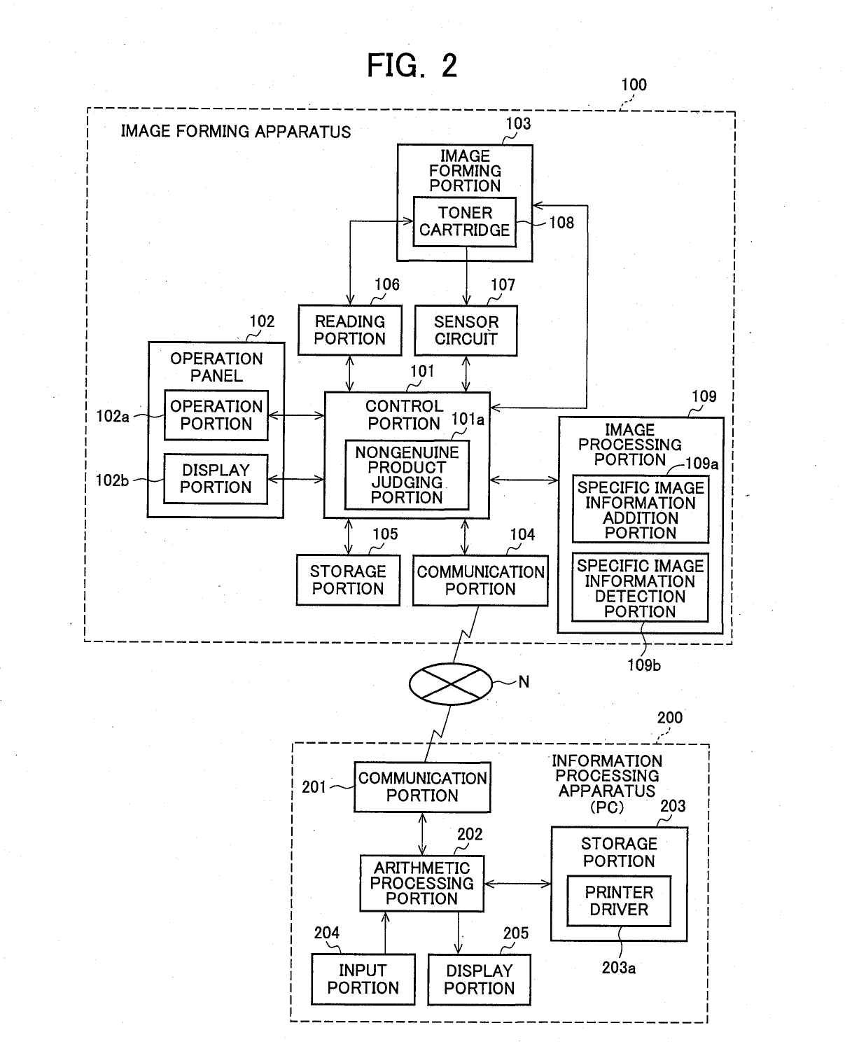

FIG. 2 is a block diagram showing an exemplary main configuration of the image forming apparatus and an information processing apparatus in the image forming system according to the present invention.

The image forming apparatus 100 is configured as, for example, the above-described multi-functional peripheral, which is comprised of a control portion 101 for controlling each function of the image forming apparatus 100 to be realized by a microcomputer having a CPU, a ROM, a RAM and the like inside thereof; an operation panel 102 composed of an operation portion 102a and a display portion 102b; an image forming portion 103 for performing image formation of image data on recording paper according to control of the control portion 101; a communication portion 104 for connecting to an information processing apparatus 200 via a network N; a storage portion 105 such as a hard disk; a reading portion 106 for reading ID information from an IC chip imparted to a toner cartridge 108; a sensor circuit 107 composed of a peripheral circuit for processing various sensors and signals from the sensors; the toner cartridge 108 as an example of a replacement part; and an image processing portion 109 for performing processing for adding specific image information to recording paper.

The operation panel 102 is composed of the operation portion 102a and the display portion 102b, and the operation portion 102a receives operation input by a user for outputting to the control portion 101. Further, the display portion 102b displays a screen for operation and various types of information. A touch panel on which input operation is enabled with respect to an operation screen by the operation portion 102a and the display portion 102b is configured.

A main object of the present invention is to prevent leakage of a confidential matter by prohibiting addition of specific image information to recording paper on a print condition input screen of a printer driver of an information processing apparatus in the case of using a nongenuine product as a replacement part. As a configuration therefor, the image forming apparatus 100 is provided with a nongenuine product judging portion 101a for judging whether or not a replacement part of the image forming portion 103 is a nongenuine product, and the control portion 101 for controlling the image forming portion 103 according to an image forming condition set by a printer driver 203a.

Then, in a case where the replacement part of the image forming portion 103 is judged as a nongenuine product by the nongenuine product judging portion 101a, the control portion 101 stores such a judgment result in the storage portion 105 as genuine part judgment information. Additionally, the control portion 101 sends, in the case of having a sending request of the genuine part judgment information from the information processing apparatus 200, the genuine part judgment information that is stored in the storage portion 105 to the information processing apparatus 200 via the communication portion 104. Note that, the nongenuine product judging portion 101a is realized as one function of the control portion 101.

In the above description, the replacement part configures a part of an apparatus in light of a function, whose performance is able to be recovered and retained by replacement. For example, a toner cartridge (or development cartridge), a photoreceptor cartridge, a cartridge in which a development member and a photoreceptor are integrally formed, an ink cartridge, a cartridge in which an ink tank and a print head are integrally formed, an ink sheet cartridge for a thermal transfer formula, and the like are applicable for the image forming apparatus 100. Then, these replacement parts are referred to as supplies in some cases. In description of the present embodiment, the toner cartridge 108 will be illustrated and explained as a replacement part, however, is not limited thereto.

In FIG. 2, the nongenuine product judging portion 101a judges whether the toner cartridge 108 mounted on the image forming apparatus 100 is a genuine product or a nongenuine product. A judging method of the nongenuine product is able to be realized by means of conventional public known techniques of, for example, Japanese Laid-Open Patent Publication No. 2002-202697, Japanese Laid-Open Patent Publication No. 2009-145396 and the like in addition to techniques described in the above-described Japanese Laid-Open Patent Publication No. 2010-266588 and Japanese Laid-Open Patent Publication No. 2009-300694, which method is not particularly limited. Hereinafter, description will be given as an illustration for a case where judgment is made in the image forming apparatus 100 as a judging method of a nongenuine product by the nongenuine product judging portion 101a, however, an external server device or the like may be used for judgment.

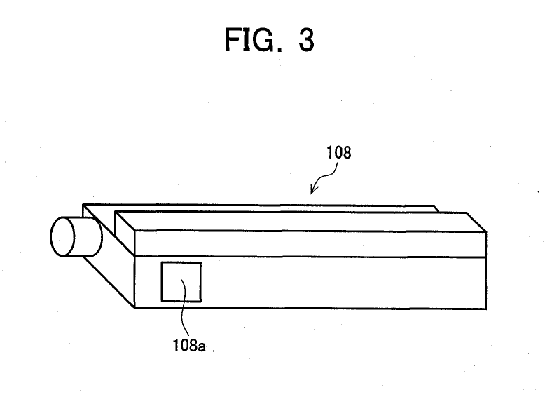

In the toner cartridge 108, inherent ID information capable of individually specifying the toner cartridge 108 is recorded. For example, as shown in FIG. 3, the ID information is installed as an IC chip 108a to be recorded in advance in a non-volatile memory such an EEPROM and a ferroelectric memory inside thereof. Alternatively, such ID information may be configured by a simple method such as a bar code. The ID information may be an identification number or the like of a manufacturer because of only needing to recognize at least a manufacturer supplying a genuine product. Additionally, a configuration of the reading portion 106 differs depending on a form of the ID information imparted to the toner cartridge 108. For example, the reading portion 106 is a bar code reader in a case where the ID information is a bar code, or the reading portion 106 is comprised of electric or high-frequency reading means in a case where the ID information is an IC chip.

Additionally, in the storage portion 105, ID information of a genuine product of a toner cartridge is stored in advance, and in the case of confirming the toner cartridge 108 is replaced and mounted, the nongenuine product judging portion 101a compares ID information of the toner cartridge 108 read by the reading portion 106 to ID information of a genuine product stored in the storage portion 105 to judge whether or not both of them are consistent with each other. Note that, a manufacturer of the image forming apparatus 100 may store all of ID information of a genuine toner cartridge in the storage portion 105 at a manufacturing process thereof. In a case where the ID information is consistent with each other, judgment is made as a genuine product, and in a case where ID information is not consistent with each other, judgment is made as a nongenuine product. Note that, to some nongenuine products, ID information is not imparted in some cases, thus allowing to judge as a nongenuine product in the case of being incapable of reading the ID information at the reading portion 106.

In the above description, replacement and mounting of the toner cartridge 108 are detectable by the sensor circuit 107. The sensor circuit 107 is, as described above, composed of a peripheral circuit for processing various sensors and signals from the sensors. The sensor is composed of a mechanical or optical door sensor and a cartridge sensor. The door sensor is a sensor for detecting an opening/closing state of a door of the image forming apparatus 100, and the cartridge sensor is a sensor for detecting whether or not the toner cartridge 108 is mounted on the image forming apparatus 100. The peripheral circuit includes a waveform shaping circuit for performing waveform shaping of sensor output, a filter circuit, a binarized circuit, a voltage level control circuit, and the like, in which the sensor output is converted to, for example, a digital signal having a logic level of 0 to 5V.

The control portion 101 accesses the IC chip 108a when detecting that the toner cartridge 108 is replaced in the sensor circuit 107, and instructs the reading portion 106 to read ID information. Then, the nongenuine product judging portion 101a compares the ID information read by the reading portion 106 to ID information stored in the storage portion 105, thereby judging whether the replaced toner cartridge 108 is a genuine product or a nongenuine product. In this manner, the nongenuine product judging portion 101a is able to judge whether the ID information is consistent/inconsistent with each other. Even in the case of being incapable of reading by the reading portion 106, judgment is supposed to be made as inconsistency, that is, a nongenuine product.

The image processing portion 109 has a function for applying image change processing to image data read by a scanner (image reading means) and print data transmitted from outside such as the information processing apparatus 200. The image change processing includes magnification changing setting for specified magnification, magnification changing setting for specified sheet, setting for binding margins, collective setting which is referred to as “n in 1” and the like. Further, the image processing portion 109 is provided with a specific image information addition portion 109a and a specific image information detection portion 109b.

The specific image information addition portion 109a is to realize processing for adding specific image information concerning the present invention to recording paper, and has a function for adding the specific image information indicating a specified image to image data that is input by various image input means. After the above-described image change processing is performed, the specific image information addition portion 109a adds the specific image information, so that it is possible to add constant specific image information without processing of variable magnification, rotation or the like, which also allows easier detection. Additionally, the specific image information includes, for example, a watermark, copy prohibition information, trace information or the like described above, all of which relate to security.

The image processing portion 109 preferably includes the specific image information detection portion 109b for detecting whether or not the specific image information is included in image data read by the scanner (image reading means) to be saved in the storage portion 105. In a case where, as a result of detection by the specific image information detection portion 109b, the specific image information for prohibiting copying with a background pattern in the image data is included, the control portion 101 performs control for prohibiting copying of the image data (image formation in the image forming portion 103 is rendered ineffective).

Subsequently, the information processing apparatus 200 is, for example, a versatile PC (personal computer) which is comprised of a communication portion 201 for connecting to the image forming apparatus 100 via the network N; an arithmetic processing portion 202 composed of a-CPU, a RAM, a ROM and the like for controlling each function of the information processing apparatus 200; a storage portion 203 such as a hard disk in which the printer driver 203a is installed; an input portion 204 such as a keyboard and a mouse; and a display portion 205 such as a liquid crystal display.

The printer driver 203a is software (program) which controls the image forming apparatus 100 for executing image forming processing (print processing). This printer driver 203a is read from the storage portion 203 by the arithmetic processing portion 202 in execution of printing to be developed and executed on the RAM of the arithmetic processing portion 202. Then, the printer driver 203a displays a print condition input screen (also referred to as a print condition setting screen) on the display portion 205, thereby presenting a user various image forming conditions, while the image forming condition is set corresponding to input operation by the user from the input portion 204. The image forming condition is sent to the image forming apparatus 100 with print data via the communication portion 201, and the print data is processed by the image processing portion 109 according to the image forming condition in the image forming apparatus 100, followed by printing of the processed print data on recording paper at the image forming portion 103.

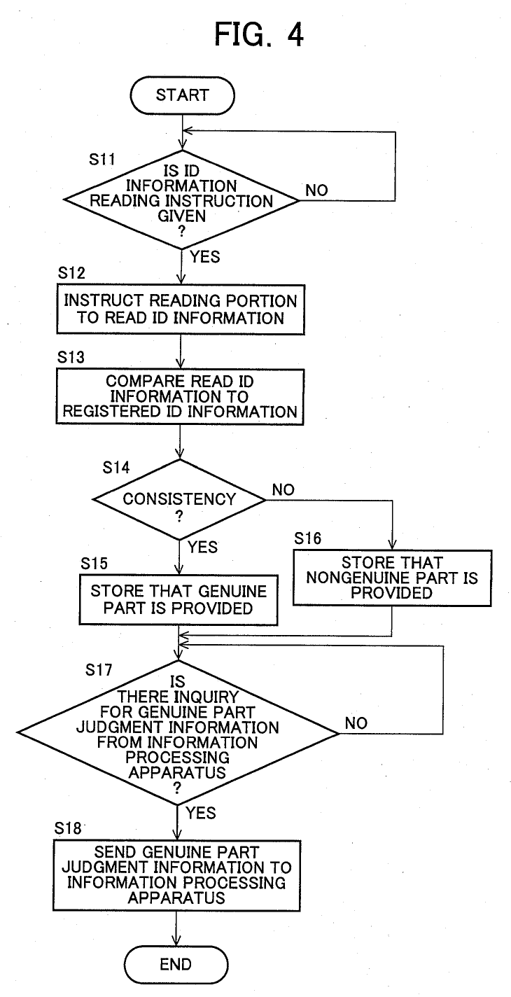

FIG. 4 is a flow diagram for explaining an example of operation of the image forming apparatus in the image forming system of the present invention. In this example, description will be given for a case where an ID information reading instruction is given when the sensor circuit 107 detects the toner cartridge 108 is mounted based on the configuration of the image forming apparatus 100 of FIG. 2.

First, the control portion 101 judges whether or not the ID information reading instruction is given from the sensor circuit 107 along with mounting of the toner cartridge 108 (step S11), and in the case of judging that the ID information reading instruction is given (in the case of YES), instructs the reading portion 106 to read ID information of the toner cartridge 108 (step S12). Moreover, at step S11, in the case of judging that the ID information reading instruction is not given (in the case of NO), the process moves to a standby state at step S11.

Next, the control portion 101 (nongenuine product judging portion 101a) compares ID information read by the reading portion 106 to ID information stored in the storage portion 105 (registered ID information) (step S13). Then, the control portion 101 judges whether or not both of them are consistent with each other (step S14), and in the case of being consistent with each other (in the case of YES), judges the toner cartridge 108 as a genuine product to store the genuine part judgment information in the storage portion 105 that a genuine part is provided (step S15). Additionally, in the case of being not consistent with each other, judgment is made that the toner cartridge 108 is a nongenuine product, and the control portion 101 stores the genuine part judgment information in the storage portion 105 that a nongenuine part is provided (step S16). Here, the step S14 corresponds to a nongenuine product judging step.

In step S15 and step S16, the genuine part judgment information is stored in the storage portion 105, thereafter the process moves to step S17, and the control portion 101 awaits an inquiry for the genuine part judgment information from the information processing apparatus 200. In the case of having the inquiry for the genuine part judgment information from the information processing apparatus 200 in step S17, the control portion 101 reads the genuine part judgment information from the storage portion 105 for sending to the information processing apparatus 200 (step S18). Further, in the case of having no inquiry, the process moves to a standby state at step S17, however, during the standby state, in a case where the ID reading instruction described in step S11 is given, the process moves to step S11 to repeat subsequent processing. Here, the step S18 corresponds to a communicating step of the present invention.

In an operation flow shown in FIG. 4, the genuine part judgment information is stored in the storage portion 105, thereafter awaiting the inquiry of the genuine part judgment information from the information processing apparatus 200, however, the image forming apparatus 100 may send, in the case of recognizing the information processing apparatus 200 that is connected to the image forming apparatus 100, the genuine part judgment information to the information processing apparatus 200 each time the genuine part judgment information is updated.

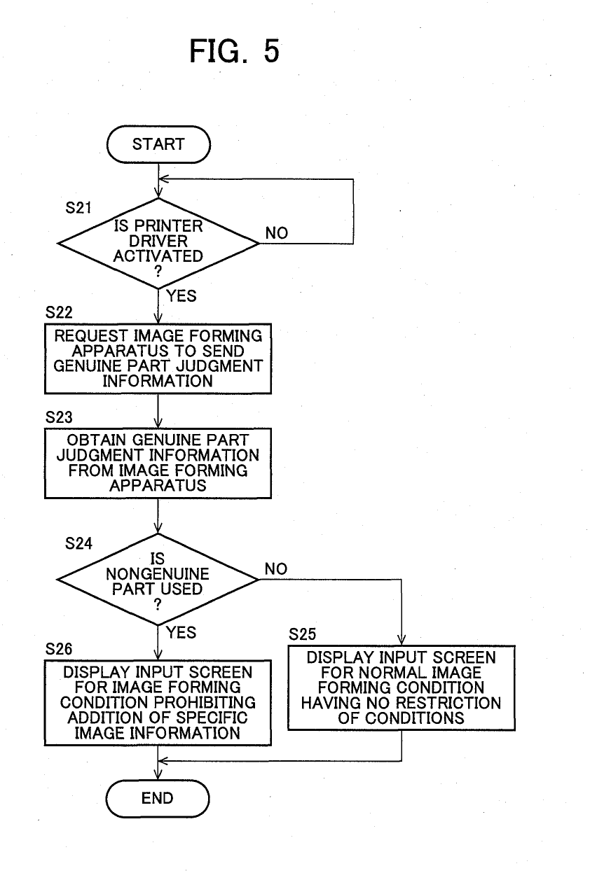

Next, description will be given for operation of the information processing apparatus 200. FIG. 5 is a flow diagram explaining an example of operation of the information processing apparatus in the image forming system of the present invention.

First, the arithmetic processing portion 202 judges whether or not the printer driver is activated by operation of a user (step S21), and in a case where the printer driver is activated (in the case of YES), requests the image forming apparatus 100 to send the genuine part judgment information (step S22). Moreover, in step S21, in a case where the arithmetic processing portion 202 judges that the printer driver is not activated (in the case of NO), the process moves to a standby state in step S21.

Following step S22, the genuine part judgment information is obtained from the image forming apparatus 100 (step S23), and the process moves to step S24. In step S24, the arithmetic processing portion 202 determines whether a nongenuine part is used for the image forming apparatus 100 based on the genuine part judgment information. Then, in the case of determining that a nongenuine part is not used, that is, a genuine part is used, the process moves to step S25, and the arithmetic processing portion 202 displays on the display portion 205, according to predetermined operation by a user, a print condition input screen for a normal image forming condition having no restriction of conditions. Moreover, in the case of determining that a nongenuine part is used in step S24, the process moves to step S26, and the arithmetic processing portion 202 displays on the display portion 205 a print condition input screen for an image forming condition prohibiting addition of specific image information to recording paper. Here, the step S26 corresponds to an input restricting step of the present invention.

In step S26, the specific image information relates to security, and more specifically, is any of a watermark, copy prohibition information or printed material trace information. Additionally, on the print condition input screen for a normal image forming condition having no restriction of conditions, a setting item for selecting the specific image information to be added to recording paper is displayed on the display portion 205 so as to be settable. However, on the print condition input screen prohibiting addition of the specific image information, a setting item for adding the specific image information is hidden or displayed in gray-out, so that it is impossible to select and set the specific image information.

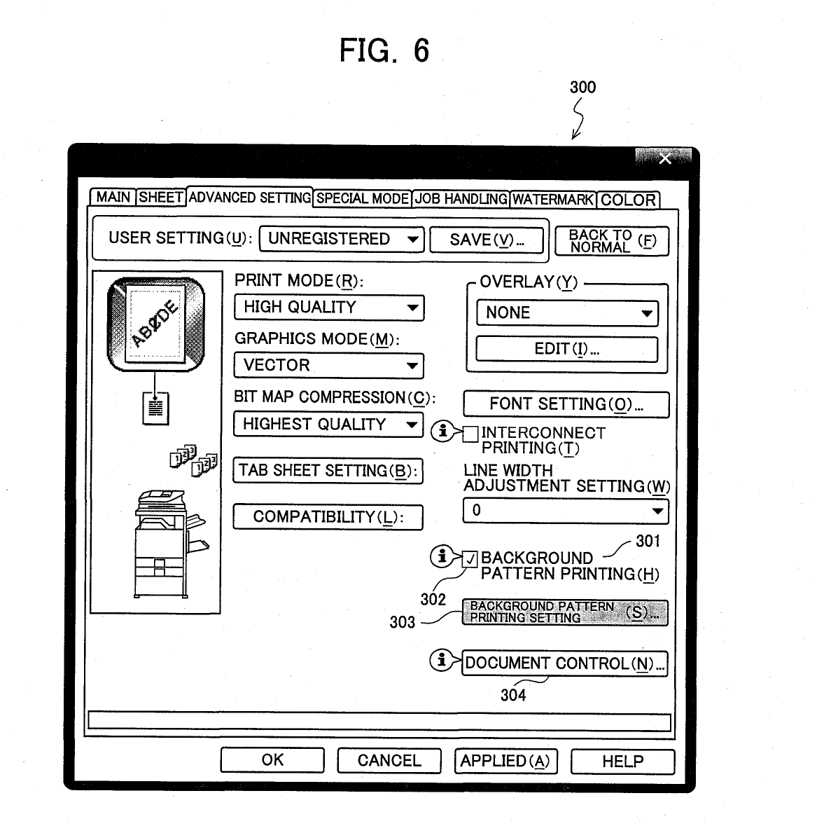

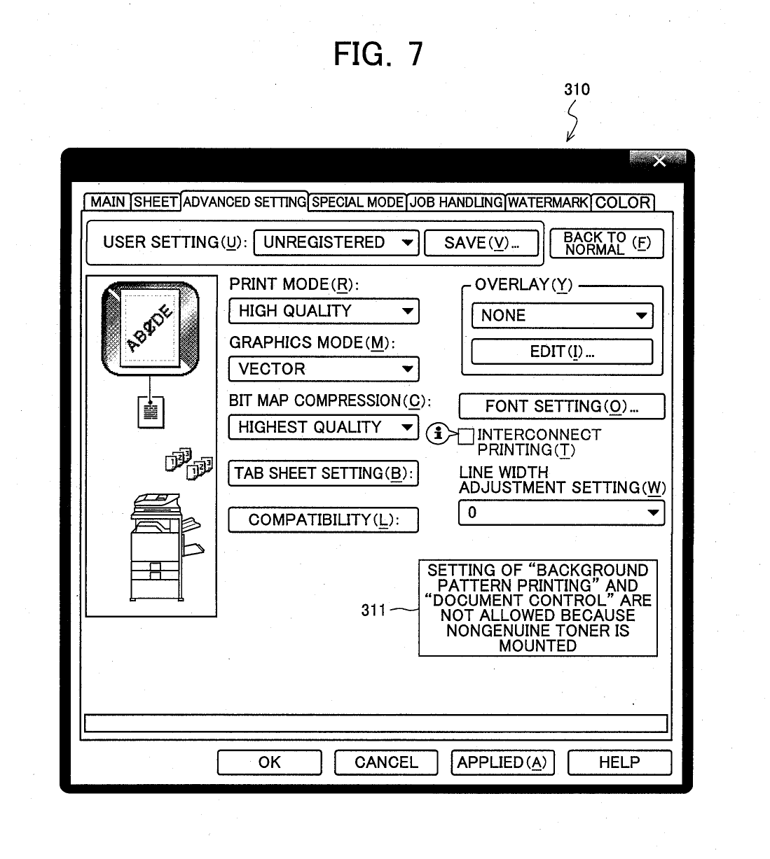

Hereinafter, description will be first given by taking the case of performing background pattern printing as an example with reference to FIG. 6 and FIG. 7 for an example of a print condition input screen of the printer driver 203a of the information processing apparatus 200 in print processing of the image forming apparatus 100.

FIG. 6 is a print condition input screen 300 of a printer driver for setting various image conditions that is displayed on the display portion 205 of the information processing apparatus 200 in the case of performing conventional background pattern printing, and when a user wishes to perform the background pattern printing, in the case of adding a check mark by clicking a box 302 on a left side of display of background pattern printing 301, it is possible to select display of background pattern printing setting 303 which is detailed setting of the background pattern printing.

A background pattern printing mode is a function for printing a watermark character or a hidden character in the background of an image, and aims to, when a printing result is retrieved again to the image forming apparatus as a copy or scan data, exhibit that an image brought by replicated data is provided, or prohibit copying itself. Additionally, in the case of the present invention, when the printer driver is activated, and a nongenuine part is not used in the image forming apparatus 100, the print condition input screen 300 capable of selecting and setting the background pattern printing is displayed on the display portion 205. Further, display for document control 304 is to embed data for prevention of unauthorized copying in the case of outputting a document such as a confidential document, and to perform setting for adding copy prohibition information as with the background pattern printing. Then, the display 304 is selected so that it is possible to set details of the data of prevention of unauthorized copying.

On the other hand, FIG. 7 is a diagram showing an example of a print condition input screen with a printer driver in the case of using a nongenuine product in the image forming apparatus. On a print condition input screen 310 shown in FIG. 7, setting items concerning the display of background pattern printing 301, the box 302, background pattern printing of the display of background pattern printing setting 303 and the like, as well as document control 304 which are displayed on the normal print condition input screen 300 are hidden so as not to allow selection and setting of the background pattern printing. Additionally, a message 311 that “Setting of “background pattern printing” and “document control” are not allowed because nongenuine toner is mounted” may be displayed, thereby informing a user of a reason that the background pattern printing is not selectable, so that user's awareness for a nongenuine part is enhanced.

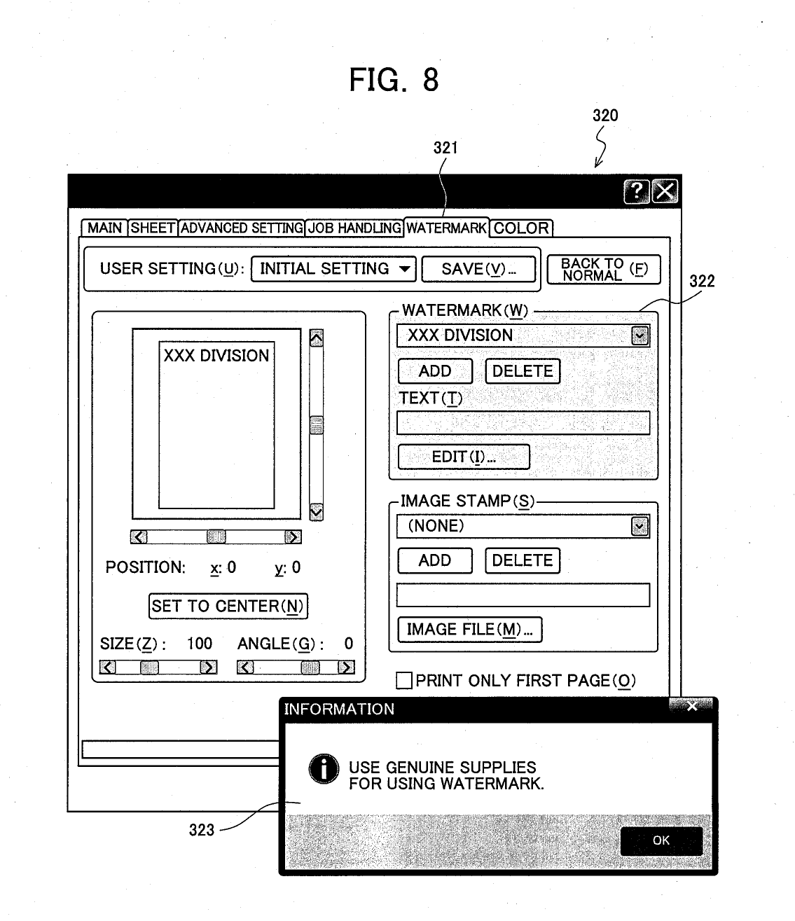

FIG. 8 is a diagram showing another example of the print condition input screen with the printer driver in the case of using a nongenuine product in the image forming apparatus, showing an example of the case of prohibiting setting of a watermark.

When a user selects a tab of watermark 321 as the print condition input screen, a print condition input screen 320 shown in FIG. 8 is displayed. Additionally, on the print condition input screen 320, a setting item 322 of a watermark whose input setting is allowed on the normal print condition input screen in the case of using a genuine part is displayed in gray-out so as not to allow addition of a watermark to recording paper. Further, the tab of watermark 321 is selected, and at the same time, a message 323 that “Use genuine supplies for using watermark” may be displayed on the display portion 205.

Note that, in the above-described embodiment, in a case where a nongenuine part is used, on the print condition input screen, a setting item concerning addition of specific image information is hidden or displayed in gray-out, thereby prohibiting selection and input, however, the setting item may be kept displayed, and when a user attempts to select or input such a displayed item, a message requesting use of, genuine supplies may be displayed so as not to allow selection and input of the displayed item.

As described above, when a nongenuine product is used for printing of an important document, a document to be submitted or the like, and additional information or the like indicating importance of a printed material as described above is not transferred to recording paper, there is a possibility to pose a problem, however, according to the present invention, for a nongenuine product incapable of being assured by a manufacturer of a multi-functional peripheral, functions of a watermark, background pattern printing and the like are prohibited, so that it is possible to suppress poor printing of a document by special printing.

Hereinabove, according to the present invention, when judgment is made that a nongenuine product other than a genuine product supplied by a manufacturer is used inside an image forming apparatus, addition of specific image information to recording paper is prohibited among image forming conditions capable of being input, thus making it impossible to add a watermark, copy prohibition information or trace information that is purposely added with recognition of an important document by a user, so that even a user who does not recognize use of a nongenuine product is able to understand that printing desired by the user is not able to be performed, thereby making it possible to prevent leakage of the important document.

1. An image forming system in which an information processing apparatus to which a printer driver is installed and an image forming apparatus that is controlled by the printer driver are connected to each other via a network, wherein
the image forming apparatus is provided with an image forming portion for forming an image; a nongenuine product judging portion for judging whether or not a replacement part of the image forming portion is a nongenuine product; and a communication portion for sending a judgment result by the nongenuine product judging portion to the information processing apparatus, wherein
the printer driver of the information processing apparatus prohibits, when the judgment result from the image forming apparatus is a nongenuine product, addition of specific image information to recording paper among image forming conditions capable of being input from a print condition input screen of the printer driver.

2. The image forming system as defined in claim 1, wherein
the specific image information is any of a watermark, copy prohibition information or printed material trace information.

3. The image forming system as defined in claim 1, wherein
the printer driver of the information processing apparatus hides, when the judgment result from the image forming apparatus is a nongenuine product, a setting item concerning addition of the specific image information to recording paper on the print condition input screen.

4. The image forming system as defined in claim 1, wherein
the printer driver of the information processing apparatus displays in gray-out, when the judgment result from the image forming apparatus is a nongenuine product, a setting item concerning addition of the specific image information to recording paper on the print condition input screen.

5. The image forming system as defined in claim 1, wherein
the nongenuine product judging portion judges, in the case of being incapable of obtaining predetermined information from a replacement part of the image forming portion, that the replacement part is a nongenuine part.

6. An image forming method in an image forming system in which an information processing apparatus to which a printer driver is installed and an image forming apparatus that is controlled by the printer driver are connected to each other via a network, wherein
the image forming apparatus includes an image forming portion for forming an image; a nongenuine product judging step for judging whether or not a replacement part of the image forming portion is a nongenuine product; and a communicating step for sending a judgment result in the nongenuine product judging step to the information processing apparatus, wherein
the printer driver of the information processing apparatus includes an input restricting step of prohibiting, when the judgment result from the image forming apparatus is a nongenuine product, addition of specific image information to recording paper among image forming conditions capable of being input from a print condition input screen of the printer driver.

7. The image forming system as defined in claim 2, wherein
the printer driver of the information processing apparatus hides, when the judgment result from the image forming apparatus is a nongenuine product, a setting item concerning addition of the specific image information to recording paper on the print condition input screen.

8. The image forming system as defined in claim 2, wherein
the printer driver of the information processing apparatus displays in gray-out, when the judgment result from the image forming apparatus is a nongenuine product, a setting item concerning addition of the specific image information to recording paper on the print condition input screen.

9. The image forming system as defined in claim 2, wherein
the nongenuine product judging portion judges, in the case of being incapable of obtaining predetermined information from a replacement part of the image forming portion, that the replacement part is a nongenuine part.
